(19) United States
(12) Patent Application Publication
(10) Pub. No.: US 2004/0192858 A1
(43) Pub. Date: Sep. 30, 2004

(54) Solution composition of aromatic liquid-crystalline polyester

(75) Inventors: Shiro Katagiri, Tsukuba-shi (JP); Satoshi Okamoto, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/799,710

(22) Filed: Mar. 15, 2004

(30) Foreign Application Priority Data
Mar. 25, 2003 (JP) 2003-082379

(51) Int. Cl. C08G 63/02; C08L 77/00

(52) U.S. Cl. 525/419; 525/437

(57) ABSTRACT

The present invention is to provide a solution composition of aromatic liquid-crystalline polyester from which a film excellent in an electric property and mechanical strength is produced. The present invention provides a solution composition comprising a solvent, aromatic liquid crystalline polyester, an inorganic filler, and coupling agent having a boiling point of not less than 250° C., wherein a pH of water solution of the coupling agent is from 4 to 8.

### FIELD OF THE INVENTION

The present invention relates to a solution composition of aromatic liquid-crystalline polyester.

### BACKGROUND OF THE INVENTION

Aromatic liquid-crystallinepolyesters are widely used in various fields and mainly used in precision parts of eletronic devices such as a connecter produced by injection molding method, because liquid-crystalline polyesters shows low water absorption, excellent dielectric property at high frequency, high heat resistance and excellent mechanical properties. Recently, it is explored that a film of aromatic liquid-crystalline polyesters molded by extrusion process or tubular process is used for a multilayered printed wiring board or flexible printed wiring board.

However, a film of aromatic liquid-crystalline polyesters produced by extrusion process or tubular process has large anisotropy, resulting in weak tear strength along the direction perpendicular to the flow direction during molding, and therefore, a breakage of the obtained film is occurred during handling the film.

In order to suppress the above problem, it is suggested that the film of aromatic liquid-crystalline polyesters is produced by a method of casting a solution including liquid-crystalline aromatic polyester and solvent containing halogen substituted phenol on a substrate and removing the solvent (JP 2002-114894). The obtained film shows small anisotropy to give a film excellent in tear strength along the direction perpendicular to the flow direction.

In order to improve an electric property of the film, while it has been tried that an inorganic filler such as barium titanate, titanium oxide, the addition of an inorganic filler deteriorates mechanical properties of the film.

### SUMMARY OF THE INVENTION

The present invention is to provide a solution composition of aromatic liquid-crystalline polyester from which a film excellent in an electric property and mechanical strength is produced.

The present inventors have intensively studied to find a solution composition of aromatic liquid-crystalline polyester providing above film, and resultantly found that a solution composition of aromatic liquid-crystalline polyester comprising an inorganic filler and a coupling agent having a boiling point of not less than 250° C., wherein a pH of water solution of the coupling agent is from 4 to 8, provides a film excellent in an electric property and mechanical strength, and then completed the present invention.

Namely, the present invention provides a solution composition comprising a solvent, aromatic liquid-crystalline polyester, an inorganic filler, and a coupling agent having a boiling point of not less than 250° C., wherein a pH of water solution of the coupling agent is from 4 to 8.

### PREFERABLE EMBODIMENT OF THE PRESENT INVENTION

The present invention will be described in detail below.

The present invention is directed to a solution composition comprising aromatic liquid-crystalline polyester, an inorganic filler, and a coupling agent having a boiling point of not less than 250° C., wherein a pH of water solution of the coupling agent is from 4 to 8.

The aromatic liquid crystalline polyester used in the present invention is a polyester called thermotropic liquid-crystalline polyester, and shows optical anisotropy in melting at temperatures of 450° C. or less.

The aromatic liquid-crystalline polyester used for the present invention include, for example:

(1) a polymer comprising a repeating unit derived from aromatic hydroxycarboxylic acids, a repeating unit derived from aromatic dicarboxylic acids and a repeating unit derived from an aromatic diols,

(2) a polymer comprising repeating units derived from different aromatic hydroxycarboxylic acids,

(3) a polymer comprising a repeating unit derived from aromatic dicarboxylic acids and a repeating unit derived from aromatic diols,

(4) a polymer prepared by reaction of polyesters such as polyethylene terephthalate with aromatic hydroxycarboxylic acids; and the like. In place of such aromatic hydroxycarboxylic acids, aromatic dicarboxylic acids or aromatic diols, ester formable derivatives thereof such as derivatives having ester forming property may be used to obtain the above polyester.

The ester formable derivatives of a carboxylic acid may include, for example, those in which a carboxyl group is present in the form of an acid chloride or an acid anhydride so as to promote an ester formation reaction with high reactivity, or those in which a carboxyl group forms an ester with alcohols, ethylene glycol and the like so that apolyester is formed by a transesterification reaction.

The ester formable derivatives of a phenolic hydroxyl group may include, for example, those in which a phenolic hydroxyl group forms an ester with carboxylic acids so that polyester is formed by a transesterification reaction.

Aromatic hydroxycarboxylic acids, aromatic dicarboxylic acids and aromatic diols may also be substituted with a halogen atom such as chlorine, fluorine and the like, an alkyl group such as a methyl group, ethyl group and the like, an aryl group such as a phenyl group and the like, or other groups not disturbing their ester forming property.

Examples of repeating units constituting the aromatic liquid-crystalline polyester include the following units.

Repeating units derived from aromatic hydroxycarboxylic acids:

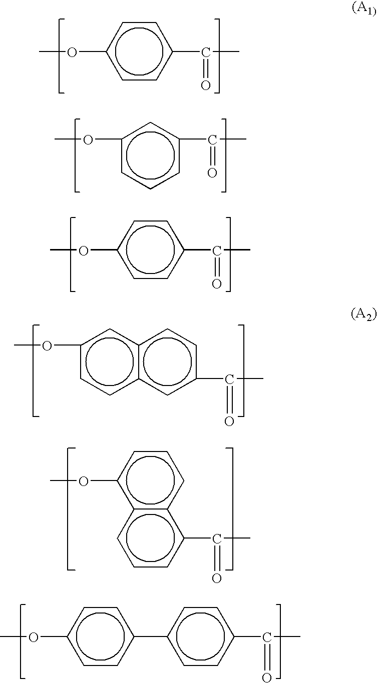

The above-mentioned repeating units may be substituted with a halogen atom or an alkyl group.

Repeating units derived from aromatic dicarboxylic acids:

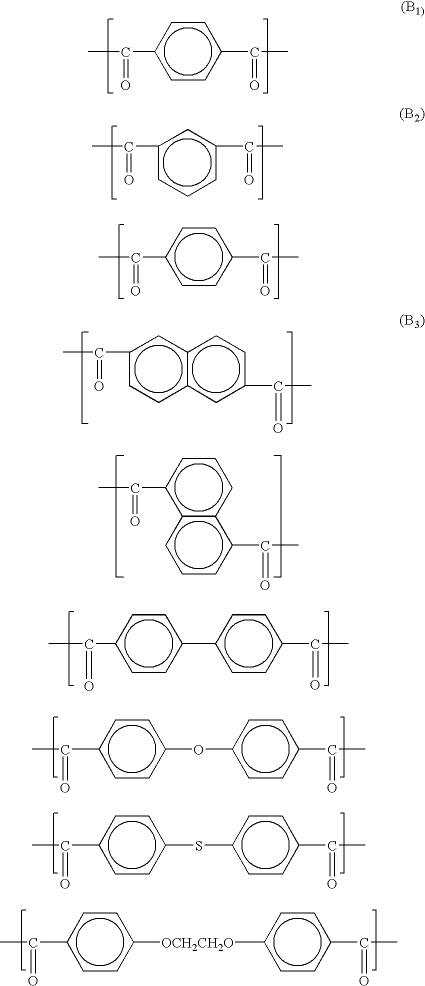

The above-mentioned repeating units may be substituted with a halogen atom, an alkyl group or an aryl group.

Repeating units derived from aromatic diols:

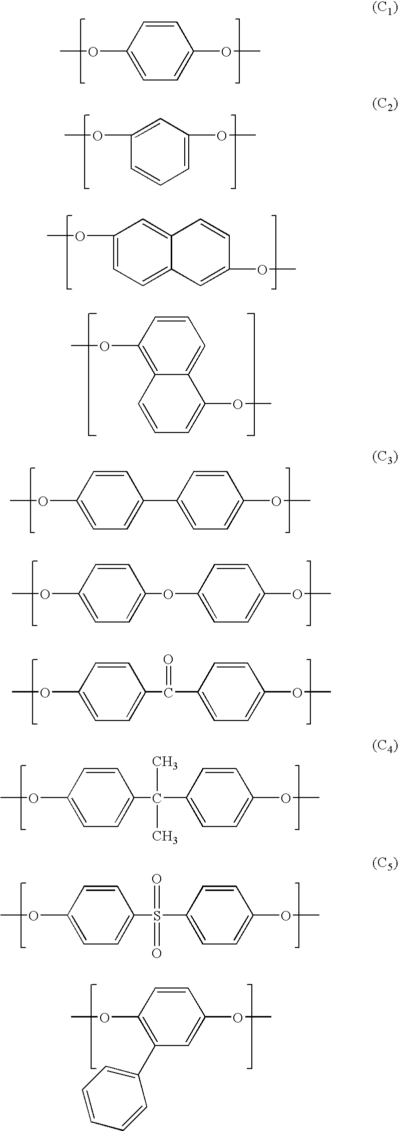

The above-mentioned repeating units may be substituted with a halogen atom, an alkyl group or an aryl group.

Among the above-mentioned alkyl group, alkyl groups having 1 to 10 carbon atoms are preferable, and among the above-mentioned aryl group, aryl groups having 6 to 20 carbon atoms are preferable.

From a viewpoint of good balance of heat resistance, mechanical properties, preferable are aromatic liquid crystalline polyesters containing at least 30% of the repeating unit of the above-described formula A₁ or A₂.

Those having combinations of the repeating units as following (a) to (f) are preferable.

(a): a combination of (A₁), (B₂), and (C₃), a combination of (A₂), (B₂) and (C₃), a combination of (A₁), a mixture of (B₁) and (B₂), and (C₃), or a combination of (A₂), a mixture of (B₁) and (B₂), and (C₃)

(b): the combination in which (C₃) is partly or wholly replaced with (C₁) in each combination of above (a)

(c): the combination in which (C₃) is partly or wholly replaced with (C₂) in each combination of above (a)

(d): the combination in which (C₃) is partly or wholly replaced with (C₄) in each combination of above (a)

(e) the combination in which (C₃) is partly or wholly replaced with a mixture of (C₄) and (C₅) in each combination of above (a).

(f): the combination in which (A₁) is partly replaced with (A₂) in each combination of above (a)

From the viewpoint of a heat resistance, the preferable aromatic liquid-crystalline polyesters are those comprising 30 to 80 mol% of a repeating unit derived from p-hydroxybenzoic acidorp-hydroxy-6-naphthoicacid, 10 to35mol% of a repeating unit derived from at least one compound selected from the group consisting of hydroquinone and 4,4′-dihydroxybiphenyl, and 10 to 35 mol% of a repeating unit derived from at least one compound selected from the group consisting of terephthalic acid and isophthalic acid.

The weight-average molecular weight of the aromatic liquid crystalline polyester is not particularly limited and preferably from 10000 to 100000.

The method of producing the aromatic liquid-crystalline polyester used in the present invention is not particularly limited and may include, for example, a method in which at least one compound selected from the group consisting of aromatic hydroxycarboxylic acids and aromatic diols is acylated with an excess amount of a fatty acid anhydride to obtain an acylated compound, and by transesterifaction between the acylated compound and at least one compound selected from the group consisting of aromatic hydroxycarboxylic acids and aromatic dicarboxylic acids, the aromatic liquid-crystalline polyester is produced. As the acylated compound, fatty acid esters obtained by previous acylation may also be used.

The use amount of a fatty acid anhydride in acylation is preferably from 1.05 to 1.2 times equivalent to that of the phenolic hydroxyl group, more preferably from 1.05 to 1.1 times equivalent to that of the phenolic hydroxyl group. If the adding amount of fatty acid anhydride is less than 1.0 equivalents of the phenolic hydroxyl group, sublimation of acylated compound, aromatic hydroxycarboxylic acids and aromatic dicarboxylic acids may occur during transesterification (polycondensation) and clogging of the piping of such as reaction vessel may occur. If the adding amount of fatty acid anhydride is more than 1.2 equivalents, coloring of resultant aromatic liquid-crystalline polyester may be more significant.

The acylation reaction is preferably conducted at about 130 to about 180° C. for about 5 minutes to about 10 hours, more preferably conducted at about 140 to about 160° C. for about 10 minutes to about 3 hours.

The fatty acid anhydride used in the acylation reaction is not particularly restricted, and include, for example, acetic anhydride, propionic anhydride, butyric anhydride, isobutyric anhydride, valeric anhydride, pivalic anhydride, 2-ethylhexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride, β-bromopropionic anhydride and the like, and these may be used in admixture of two or more. From the viewpoints of its price and easy handling, acetic anhydride, propionic anhydride, butyric anhydride and isobutyric anhydride are preferable, and acetic anhydride is more preferably.

In transesterification, it is preferable that the amount of an acyl group in an acylated compound is 0.8 to 1.2 times equivalent to that of a carboxyl group.

Transesterification is preferably conducted while raising temperature from about 130 to about 400° C. at a rate of 0.1 to 50° C./min., and more preferably conducted while raising temperature from about 150 to about 350° C. at a rate of 0.3 to 5° C./min.

In transesterification of a carboxylic acid with a ester of fatty acid obtained by acylation, it is preferred that a fatty acid generated as a by-product and unreacted fatty acid anhydride are distilled off by means of a usual method such as distillation for the purpose of shifting the equilibrium.

The acylation reaction and transesterification may also be conducted in the presence of a catalyst. As the catalyst, those conventionally known as a catalyst for polymerization of apolyester can be used, and examples thereof include metal salt catalysts such as magnesium acetate, stannous acetate, tetrabutyl titanate, lead acetate, sodium acetate, potassium acetate, antimony trioxide and the like, organic compound catalysts such as N, N-dimethylaminopyridine, N-methylimidazole and the like. These catalysts are usually charged at the time of charging monomers, and are not necessarily removed after acylation, and when the catalysts are not removed, they can be used for transesterification.

Though polycondensation by transesterification is usually condected by melt polymerization, melt polymerization and solid-phase polymerization may be used together. It is preferable, in solid-phase polymerization, that a polymer is extracted from a melt polymerization process, then, ground into powder form or flake form, and subjected to a known solid-phase polymerization method. For example, a method for solid-phase polymerization include a method in which heat-treatment is conducted in solid phase at about 20 to about 350° C. under an inert atmosphere such as nitrogen for 1 to 30 hours. Solid-phase polymerization may be conducted while stirring, or conducted in static condition without stirring. Further, melt polymerization and solid-phase polymerization may also be conducted in the same reaction vessel by providing a suitable stirring mechanism. After solid-phase polymerization, the resulted aromatic liquid-crystalline polyester can be pelletized and molded by known methods.

Production of aromatic liquid-crystalline polyester can be conducted using, for example, a batch-wise apparatus, continuous apparatus and the like.

An inorganic filler used in the present invention may include, for example, silicates such as calcium silicate, aluminum silicate, talc, clay, diatomaceous earth, wollastonite and the like, agranular filler such as iron oxide, titanium oxide, zinc oxide, antimony trioxide, alumina, calcium sulfate, barium titanate, strontium titanate, silica, quartz powder, glass bead, glass balloon, glass powder and the like, a tabular filler such as mica, glass flake, a fibrous filler such as glass fiber, asbestos fiber, silica alumina fiber, potassium titanate fiber and alumina fiber, and a granular filler is preferable from the viewpoint of its dipersibility.

The adding amount of filler is preferably from 5% by volume to 70% by volume, more preferably from 30% by volume to 50% by volume, providing the total volume of an inorganic filler and aromatic liquid-crystalline polyester as 100% by volume.

When fillers are added in an amount of less than 5% by volume, the effect of addition of the filler may not be obtained. When fillers are added in an amount of over 70% by volume, the polyester may not work as binder and the obtained film may become brittle. The method of adding filler is not particularly restricted, and known methods can be employed.

A coupling agent of the present invention has a boiling point of not less than 250° C., preferably 270° C. and more preferably 290° C. If the boiling point is less than 250° C., a transpiration of coupling agent occurs and the adding effect is not obtained. The boiling point of coupling agent is measured by the method according to JIS K5601-2-3.

A water solution of coupling agent of the present invention has pH of from 4 to 8, preferably from 5 to 7. If pH is less than 4 or over 8, a viscosity of a solution composition of the present invention decrease and result in causing difficulty of film formation. A pH of a water solution of coupling agent is measured by the method according to JIS Z8802.

A coupling agent include, for example, epoxysilane coupling agents, or methacryloxysilan coupling agents. Among these, epoxysilane coupling agents is preferably used.

An example of epoxysilane coupling agents include

β-(3, 4-epoxycyclohexyl) ethyletimethoxysiline,

γ-glycidoxypropyltrimethoxysilane,

γ-glycidoxypropylmethyldimethoxysilane.

Among these, γ-glycidoxypropyltrimethoxysilane is preferable.

A coupling agent as mentioned above is usually in liquid state.

The adding amount of a coupling agent is from 0.5 to 10 parts by weight, preferably from 1 to 5 parts by weight to 100 parts by weight of inorganic filler. When the amount is less than 0.5 parts by weight, the effect of adding a coupling agent may not be obtained. When the amount is more than 10 parts by weight, the obtained film may become brittle.

From the viewpoint where a solvent to be used easily dissolves aromatic liquid-crystalline polyester at room temperature or in the heating state, a preferable solvent used in the present invention is a mixture containing a halogen-substituted phenolic compound represented by the following general formula (1), more preferable is a mixture containing 30 weight % or more of a halogen-substituted phenolic compound with respect to the amount of the mixture, further preferable is a mixture containing 60 weight % or more of the phenolic compound component, and most preferable is using substantially 100 weight % of the phenolic compound as the solvent.

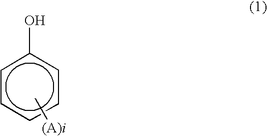

In the formula, A denotes a halogen atom or a trihalogenated methyl group and i denotes an integer of 1 to 5. In the case where i is 2 or more, a plurality of A may be the same or different, preferably the same.

A halogen atom includes a fluorine atom, a chlorine atom, a bromine atom and an iodine atom, preferably a fluorine atom and a chlorine atom, and particularly preferably a chlorine atom.

An example of the general formula (1) in which a halogen atom is a fluorine atom includes pentafluorophenol, tetrafluorophenol and the like.

An example of the general formula (1) in which a halogen atom is a chlorine atom includes o-chlorophenol and p-chlorophenol, preferably p-chlorophenol from the viewpoint of solubility.

A halogen of the trihalogenated methyl group include a fluorine atom, a chlorine atom, a bromine atom and an iodine atom.

An example of the general formula (1) in which a halogen of the trihalogenated methyl group is a fluorine atom includes 3,5-bistrifluoromethyl phenol.

The solvent to be used is preferably a solvent containing 30 weight % or more of a chlorine-substituted phenolic compound such as o-chlorophenol and p-chlorophenol from the viewpoint of costs and availability, more preferably a solvent containing 30 weight % or more of p-chlorophenol from the viewpoint of solubility.

Other components except a halogen-substituted phenolic compound may be contained in the solvent to the extent that aromatic liquid-crystalline polyester is not deposited in the conserving of the solution or the after-mentioned casting.

Other components optionally contained are not particularly limited; for example, including a compound having chlorine such as chloroform, methylene chloride and tetrachloroethane, and the like.

The ratio of aromatic liquid-crystalline polyester to a solvent containing a halogen-substituted phenolic compound (1), for example 30 weight % or more of a halogen-substituted phenolic compound (1), is preferably 0.5 to 100 parts by weight to 100 parts by weight of the solvent, from the viewpoint of workability and economy, more preferably 1 to 50 parts by weight, and further more preferably 3 to 10 parts by weight.

If content is less than 0.5 part by weight, production efficiency may be deteriorated, while a content is more than 100 parts by weight, the solubility may be decreased.

A method of adding a solvent includes a method of previously mixing aromatic liquid-crystalline polyester, an inorganic filler and a coupling agent, and thereafter adding a solvent thereto; a method of previously dissolving aromatic liquid-crystalline polyester and a coupling agent in a solvent to obtain a resin solution, filtering the solution by a filter and the like as required to remove minute foreign matters contained in the solution, and thereafter adding an inorganic filler thereto; and the like.

To the solution composition of the present invention, an organic filler such as a cured epoxy resin, a cross-linked benzoguanamine resin, a cross-linked acryl polymer, a thermoplastic resin such as a polyamides, a polyester, a polyphenylene sulfide, a polyether ketone, a polycarbonate, polyether sulfone, polyphenyl ether and a modified polymer thereof, a polyether imides and modified polymer thereof, a thermosetting resin such as a phenol resin, an epoxy resin, apolyimide resin andacyanate resin, and the various additives such as an antioxidants, UV absorption and the like may be added. These may be used in combination of two or more.

A film of aromatic liquid-crystalline polyester is obtained by a method of casting the solution composition of the present invention ona substrate, and removing the solvent.

A method of manufacturing a film includes a method of casting the solution composition of the present invention on a homogeneous substrate having a flat surface made of metal, glass and the like, and thereafter removing the solvent.

A method of removing a solvent is not particularly limited and preferably performed by vaporizing the solvent. A method of vaporizing a solvent includes a method such as heating, decompressing and ventilating. The obtained film of aromatic liquid-crystalline polyester may be further heat-treated.

Since the obtained film of aromatic liquid-crystalline polyester contains an inorganic filler, it is excellent in electric property such as electromagnetic shield, and further excellent in mechanical strength as well as low moisture absorption and excellent dielectric property at high frequency, it is preferably used for multi-layer print wiring board for semiconductor package or mother board made by build-up method, flexible print wiring board, a film for tape-automated-bonding, and a film for electromagnetic shield.

### EXAMPLES

The present invention will be illustrated based on the following examples, but it is needless to say that the scope of the present invention is not limited to the examples.

### Example 1

Into a reactor equipped with a stirrer, torque meter, nitrogen gas introducing tube, thermometer and reflux condenser was charged 141 g (1.02 mol) of p-hydroxybenzoic acid, 63.3g (0.34mol) of 4,4′-dihydroxybiphenyl, 56.5g (0.34 mol) of isophtalic acid, 191 g (1.87 mol) of acetic anhydride. The atmosphere in the reactor was thoroughly purged with a nitrogen gas, then, the mixture was heated up to 150° C. over 15 minutes under a nitrogen gas flow, and refluxed for 3 hours while maintaining the temperature.

Thereafter, the mixture was heated up to 320° C. over 170 minutes while distilling the by-produced acetic acid and unreacted acetic anhydride, and a point at which increase in torque was recognized was regarded as the end of the reaction, and the content was taken out. The resulted solid component was cooled to room temperature, ground by a fine grinder, then, heated from room temperature up to 250° C. and maintained at 250° C. for 3 hours, to progress a polymerization reaction in solid phase. Powder of aromatic liquid-crystalline polyester was obtained.

0.4g of the resulted powder were compressed-molded using CFT-500 flow tester manufactured by Shimadzu Corporation at a temperature of 250° C. under a load of 100 kg for 10 minutes to obtain a disk having 3 mm thickness as a test piece. Using this test piece, water absorption of the aromatic liquid-crystalline polyester was measured under the condition of 85° C./85%RH.168 hours by using an ADVANTEC AGX type thermo-hygrostat manufactured by Toyo Engineering Works, LTD., and the result showed the water absorption ratio of 0.1% or less. The melting temperature (the temperature of liquid crystallization) of the aromatic liquid-crystalline polyester was measured by using the DSC-50 manufactured by SHIMADZU CORPORATION to be 320° C. The dielectric loss tangent of the aromatic liquid-crystalline polyester was measured by an HP impedance analyzer manufactured by Hewlett-Packard Co. to be 0.004 (frequency: 1 GHz).

10 g of the aromatic liquid-crystalline polyester powder obtained by the above-mentioned process and 0.5 g of KBM403 of epoxysilane coupling agent (manufactured by Shin-Etsu Chemical Co., Ltd., pH: 5.3, boiling point: 230° C.) was added to 90 g of p-chlorophenol, and the solution was heated to 130° C. for 8 hours so as to be completely dissolved, whereby obtaining a transparent solution. To the obtained solution of aromatic liquid-crystalline polyester, 20 g of NPO-S manufactured by FUJI TITANIUM INDUSTRY CO., LTD. was further added as an inorganic filler to obtain a solution composition of aromatic liquid-crystalline polyester in which the inorganic filler was dispersed.

The obtained solution composition was cast on a glass base substance to vaporize the solvent by a hot plate at a preset temperature of 100° C. for 1 hour and be thereafter heat-treated by a hot-air dryer at a preset temperature of 250° C. for 1 hour, whereby obtaining aromatic liquid-crystalline polyester film.

The orientation pattern of thus obtained aromatic liquid-crystalline polyester film was measured by using MOA-5012 of molecular orientation instrument manufactured by Oji Scientific Instruments and the result showed that the ratio of longitudinal orientation to traverse orientation is 1, which means there was no anisotropy. The tensile strength of obtained film was measured to be 45 MPa.

### Comparative Example 1

The same procedure as in Example 1 was repeated to obtain powder of aromatic liquid-crystalline polyester.

10 g of the aromatic liquid-crystalline polyester powder was added to 90 g of p-chlorophenol, and the solution was heated to 130° C. for 8 hours so as to be completely dissolved, whereby obtaining a transparent solution. To the obtained solution of aromatic liquid-crystalline polyester, 20 g of NPO-S manufactured by FUJI TITANIUM INDUSTRY CO., LTD. was further added as an inorganic filler to obtain a solution of aromatic liquid-crystalline polyester in which the inorganic filler was dispersed. The obtained solution was cast on a glass base substance to vaporize the solvent by a hot plate at a preset temperature of 100° C. for 1 hour and be thereafter heat-treated by a hot-air dryer at a preset temperature of 250° C. for 1 hour, whereby obtaining aromatic liquid-crystalline polyester film.

The tensile strength of obtained film was measured to be 35 Mpa.

### Comparative Example 2

The same procedure as in Example 1 was repeated to obtain powder of aromatic liquid-crystalline polyester.

10 g of the aromatic liquid-crystalline polyester powder and 0.5 g of KBE603 of aminosilane coupling agent (manufactured by Shin-Etsu Chemical Co., Ltd., pH: 10.0, boiling point: 259 ° C.) were added to 90 g of p-chlorophenol, and the solution was heated to 130° C. for 8 hours so as to be completely dissolved, whereby obtaining a transparent solution. The viscosity of the obtained solution was too low to make a film.

### Comparative Example 3

The same procedure as in Example 1 was repeated to obtain powder of aromatic liquid-crystalline polyester.

10 g of the aromatic liquid-crystalline polyester powder and 0.5 g of A-151 of vinylsilane coupling agent (manufactured by Nippon Unicar Company Limited, pH: 3.5, boiling point: 161° C.) were added to 90 g of p-chlorophenol, and the solution was heated to 130° C. for 8 hours so as to be completely dissolved, whereby obtaining a transparent solution. The viscosity of the obtained solution was too low to make a film.

### Comparative Example 4

The same procedure as in Example 1 was repeated to obtain powder of aromatic liquid-crystalline polyester.

10 g of the aromatic liquid-crystalline polyester powder and 0.5 g of KBE403 of epoxysilane coupling agent (manufactured by Shin-Etsu Chemical Co., Ltd., pH: 4.0, boiling point: 140° C.) were added to 90 g of p-chlorophenol, and the solution was heated to 130° C. for 8 hours so as to be completely dissolved, whereby obtaining a transparent solution. To the obtained solution of aromatic liquid-crystalline polyester, 20 g of NPO-S manufactured by FUJI TITANIUM INDUSTRY CO., LTD. was further added as an inorganic filler to obtain a solution composition of aromatic liquid-crystalline polyester in which the inorganic filler was dispersed.

The obtained solution composition was cast on a glass base substance to vaporize the solvent by a hot plate at a preset temperature of 100° C. for 1 hour and be thereafter heat-treated by a hot-air dryer at a preset temperature of 250° C. for 1 hour, whereby obtaining a aromatic liquid-crystalline polyester film.

The orientation pattern of thus obtained aromatic liquid-crystalline polyester film was measured by using MOA-5012 of molecular orientation instrument manufactured by Oji Scientific Instruments and the result showed that the ratio of longitudinal orientation to traverse orientation is 1, which means there was no anisotropy. The tensile strength of obtained film was measured to be 34 MPa.

According to the present invention, a solution composition of aromatic liquid-crystalline polyester from which a film excellent in an electric property and mechanical strength is provided.

What is claimed is:

1. A solution composition of aromatic liquid-crystalline polyester comprising a solvent, aromatic liquid-crystalline polyester, an inorganic filler, and a coupling agent having a boiling point of not less than 250° C., wherein a pH of water solution of the coupling agent is from 4 to 8.

2. The solution composition of aromatic liquid-crystalline polyester according to claim 1, wherein the aromatic liquid-crystalline polyester is aromatic liquid-crystalline polyesters comprising a repeating unit derived from aromatic hydroxycarboxylic acids, a repeating unit derived from aromatic diols, and repeating unit derived from aromatic dicarboxylic acids.

3. The solution composition of aromatic liquid-crystalline polyester according to claim 2, wherein the aromatic hydroxycarboxylic acid is selected from the group consisting of p-hydroxybenzoic acid and 2-hydroxy-6-naphthoic acid, the aromatic diol is at least one compound selected from the group consisting of hydroquinone and 4,4′-dihydroxybiphenyl, and the aromatic dicarboxylic acid is at least one compound selected from the group consisting of terephthalic acid and isophthalic acid.

4. The solution composition of aromatic liquid-crystalline polyester according to claim 1, wherein the amount of the coupling agent is from 0.5 parts by weight to 10 parts by weight based on 100 parts by weight of the inorganic filler.

5. The solution composition of aromatic liquid-crystalline polyester according to claim 4, wherein the amount of the coupling agent is not less than 1 part by weight.

6. The solution composition of aromatic liquid-crystalline polyester according to claim 4, wherein the amount of the coupling agent is not more than 5 parts by weight.

7. The solution composition of aromatic liquid-crystalline polyester according to claim 1, wherein the amount of the filler is from 5% by volume to 70% by volume, providing the total volume of an inorganic filler and aromatic liquid-crystalline polyester as 100% by volume.

8. The solution composition of aromatic liquid-crystalline polyester according to claim 7, wherein the amount of the filler is no less than 30% by volume.

9. The solution composition of aromatic liquid-crystalline polyester according to claim 7, wherein the amount of the filler is not more than 50% by volume.

10. The solution composition of aromatic liquid-crystalline polyester according to claim 1, wherein the solvent contains a halogen-substituted phenolic compound.

11. The solution composition of aromatic liquid-crystalline polyester according to claim 10, wherein a content of the halogen-substituted phenolic compound is 30% by weight or more of the solvent.

12. A method for producing a film comprising casting the solution composition of aromatic liquid-crystalline polyester according to claim 1 on a substrate, and removing the solvent.

13. A film comprising aromatic liquid-crystalline polyester, an inorganic filler, and a coupling agent having a boiling point of not less than 250° C., wherein a pH of water solution of the coupling agent is from 4 to 8.

14. A film obtained by the solution composition of aromatic liquid-crystalline polyester according to claim 1.
